(19) United States
(12) Patent Application Publication
(10) Pub. No.: US 2026/0063901 A1
(43) Pub. Date: Mar. 5, 2026

(54) HEAD-UP DISPLAY DEVICE

(71) Applicant: Nippon Seiki Co.,Ltd., Niigata (JP)

(72) Inventor: Yoshiyuki Iida, Niigata (JP)

(21) Appl. No.: 19/276,216

(22) Filed: Jul. 22, 2025

(30) Foreign Application Priority Data
Aug. 27, 2024 (JP) 2024-145415

(51) Int. Cl. G02B 27/01

(52) U.S. Cl. CPC G02B 27/0149; G02B 27/0101; G02B 2027/0159

(57) ABSTRACT

To provide a lightweight head-up display device that can withstand heat due to concentration of light. A head-up display device includes, a display that emits display light, a correction mirror that reflects the display light to cause an upper end and a lower end of the display light to cross each other, a concave mirror that reflects the display light to project the display light outside the head-up display device, a case made of a synthetic resin, housing the display, the correction mirror, and the concave mirror, and having an opening unit through which the display light passes, and a blind cover made of metal, provided on an inner bottom surface of the case, and forming an optical path space through which the display light travels within the case.

### TECHNICAL FIELD

The present disclosure relates to a head-up display device.

### BACKGROUND ART

A head-up display device described in Patent Document 1 includes a first mirror, a second mirror, and a case that houses the first mirror and the second mirror, and a cross optical path is formed between the first mirror and the second mirror. In the head-up display device in which the cross optical path is formed, the temperature may increase due to concentration of sunlight inside the case. For this reason, a center frame and a top cover of the case are made of metal to withstand the heat (see paragraphs 0034 and 0037 of Patent Document 1).

### PRIOR ART DOCUMENT

### Patent Document

Patent Document 1: JP 6769481 B

### SUMMARY OF INNOVATION

### Technical Problem

In the configuration described in Patent Document 1, the metal case is used to enhance the heat resistance of the head-up display device, but the case increases the weight of the device. On the other hand, use of a resin case may reduce the weight of the head-up display device, but lowers resistance to heat due to concentration of light.

The present disclosure has been made in consideration of the above circumstances, and an object thereof is to provide a lightweight head-up display device that can withstand heat due to concentration of light.

### Solution to Problem

To achieve the above-mentioned object, a head-up display device according to the present disclosure includes a display that emits display light, a correction mirror that reflects the display light to cause an upper end and a lower end of the display light to cross each other, a concave mirror that reflects the display light to project the display light outside the head-up display device, a case made of a synthetic resin, housing the display, the correction mirror, and the concave mirror, and having an opening unit through which the display light passes, and a blind cover made of metal, provided on an inner bottom surface of the case, and forming an optical path space through which the display light travels within the case.

### Advantageous Effects of Invention

According to the present disclosure, it is possible to provide a lightweight head-up display device that can withstand heat due to concentration of light.

### BRIEF DESCRIPTION OF DRAWINGS

FIG. 1 is a schematic cross-sectional view of a head-up display device according to an embodiment of the present disclosure.

FIG. 2 is a perspective view of a head-up display device according to an embodiment of the present disclosure, with an upper case unit removed.

FIG. 3 is a perspective view of a head-up display device according to an embodiment of the present disclosure, with an upper case unit removed.

FIG. 4 is a perspective view of a blind cover and a correction mirror according to an embodiment of the present disclosure.

FIG. 5 is a perspective view of a blind cover according to an embodiment of the present disclosure.

FIG. 6 is a perspective view of a blind cover according to an embodiment of the present disclosure.

FIG. 7 is a perspective view of a blind cover according to an embodiment of the present disclosure.

FIG. 8 is a cross-sectional view taken along a line VIII-VIII in FIG. 3.

FIG. 9 is a perspective view of a blind cover according to an embodiment of the present disclosure.

FIG. 10 is a plan view of a blind cover according to an embodiment of the present disclosure. The blind cover is illustrated as being transparent and installed in a lower case unit.

### DESCRIPTION OF EMBODIMENTS

A head-up display device according to an embodiment of the present disclosure will be described with reference to the drawings.

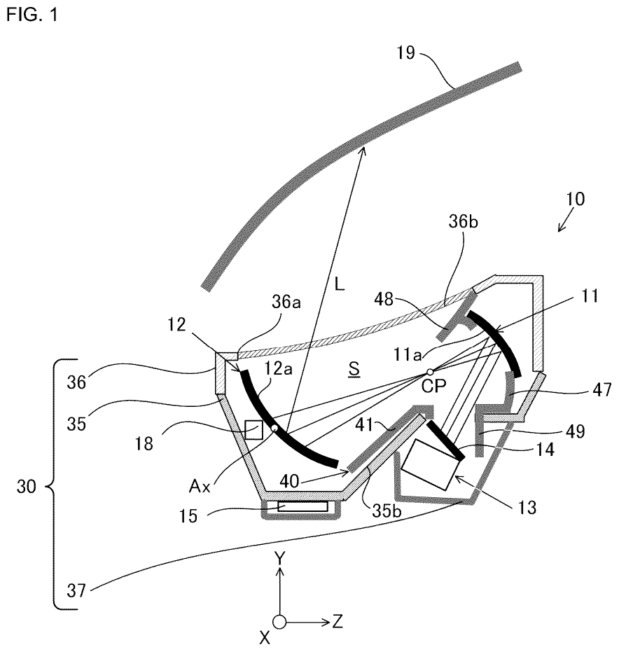

As illustrated in FIG. 1, a head-up display device 10 mounted on a vehicle displays a projection image as a virtual image including vehicle information by projecting display light L onto a windshield 19 which is an example of a member on which the image is projected. In the following description, the height direction of the vehicle is defined as a Y direction, the width direction of the vehicle is defined as an X direction, and the front-rear direction of the vehicle is defined as a Z direction.

The head-up display device 10 includes a correction mirror 11 which is an example of a fixed mirror, a concave mirror 12 which is an example of a rotatable mirror, a case 30, an illumination unit 13, a display 14, a control board 15, and a mirror rotation drive unit 18.

The illumination unit 13 emits illumination light toward the display 14 under the control of the control board 15. The illumination unit 13 includes, for example, a plurality of Light Emitting Diodes (LEDs).

The display 14 receives the illumination light from the illumination unit 13 and emits the display light L representing an image. The display 14 is, for example, a thin-film-transistor (TFT) liquid-crystal display panel.

The control board 15 controls the illumination unit 13, the display 14, and the mirror rotation drive unit 18. The control board 15 includes a central processing unit (CPU), a graphic display controller (GDC), a read only memory (ROM), a random access memory (RAM), and the like. In response to reception of vehicle information from the outside, the control board 15 causes the display 14 to display an image including the vehicle information and causes the illumination unit 13 to emit illumination light toward the display 14 that is displaying the image.

As illustrated in FIG. 1, the correction mirror 11 reflects the display light L from the display 14 toward the concave mirror 12. The correction mirror 11 has a reflecting surface 11a which is a free-form surface that corrects distortion of a virtual image caused by the shape of the windshield 19. The reflecting surface 11a of the correction mirror 11 faces obliquely downward and forward of the vehicle. The reflecting surface 11a causes the upper end and the lower end of the reflected display light L to cross each other at a cross point CP. The cross point CP is located between the correction mirror 11 and the concave mirror 12, and specifically, is located closer to the correction mirror 11 than the midpoint between the correction mirror 11 and the concave mirror 12. The curvatures of the reflecting surface 11a of the correction mirror 11 and a reflecting surface 12a of the concave mirror 12 in a cross optical system in which the display light L crosses are larger than those in a configuration in which the display light L does not cross. Larger curvatures of the reflecting surfaces 11a and 12a result in a higher degree of concentration of sunlight.

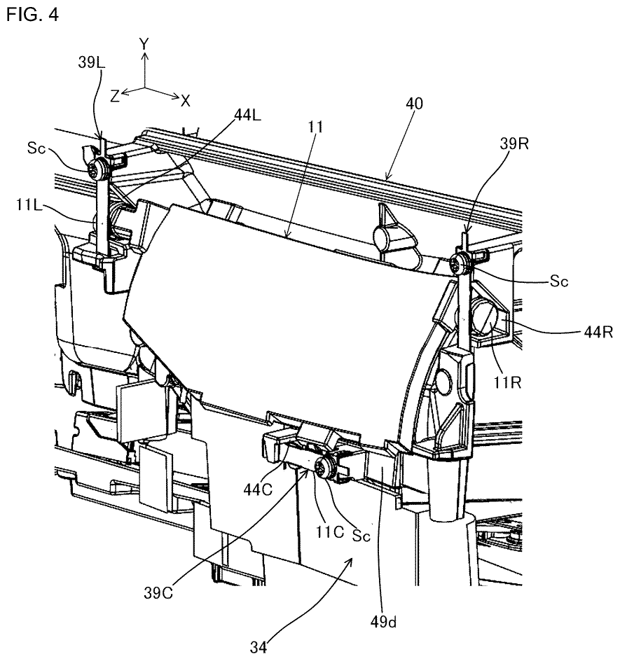

As illustrated in FIG. 4, the correction mirror 11 includes three pressed units 11L, 11R, and 11C. The two pressed units 11L and 11R are formed to protrude on both side surfaces of the correction mirror 11 in the X direction. Each of the pressed units 11L and 11R has a generally cylindrical shape extending in the X direction. The pressed unit 11C is formed to protrude on the lower side surface of the correction mirror 11.

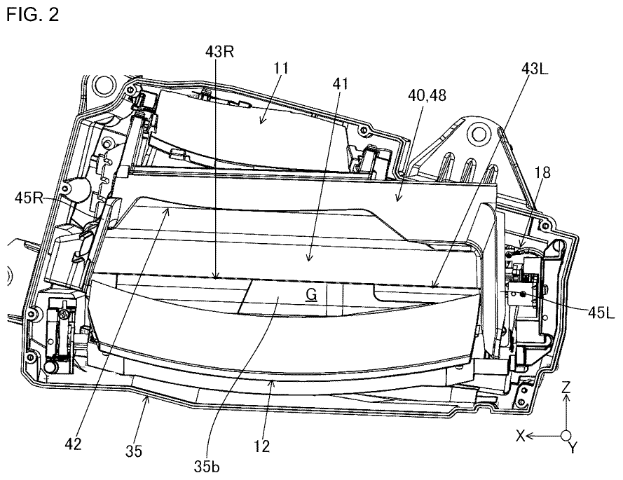

As illustrated in FIG. 1, the concave mirror 12 has the reflecting surface 12a that reflects the display light L from the correction mirror 11 toward the windshield 19. The reflecting surface 12a faces obliquely upward and rearward of the vehicle. The concave mirror 12 is, for example, a concave mirror. The lower end surface of the concave mirror 12 extends along the X direction, has a center unit in the X direction located at a lowermost position, and curves upward from the center unit toward the outside in the X direction. Both end units of the concave mirror 12 on a rotation axis Ax are supported in the case 30 to be rotatable about the rotation axis Ax. As illustrated in FIG. 2, the concave mirror 12 is formed to be long in the X direction, and the size of the concave mirror 12 in the X direction is larger than the size of the correction mirror 11 in the X direction. The concave mirror 12 and the correction mirror 11 face each other in the Z direction, the center position of correction mirror 11 in the X direction is located closer to a side wall unit 45R (described later) in the X direction than the center position of the concave mirror 12 in the X direction.

As illustrated in FIG. 1, the mirror rotation drive unit 18 rotates the concave mirror 12 about a rotation axis Ax under the control of the control board 15. The concave mirror 12 can be rotated about the rotation axis Ax to adjust the irradiation position of the display light L relative to a viewer in the Z direction.

The case 30 includes a lower case unit 35, an upper case unit 36, and a lower cover unit 37. Each unit of the case 30 is made of a resin capable of blocking light.

The lower case unit 35 has a box shape that opens upward. A blind cover 40, the correction mirror 11, the concave mirror 12, and the mirror rotation drive unit 18 are housed in the lower case unit 35.

The illumination unit 13, the display 14, and the control board 15 are installed on the outer bottom surface of the lower case unit 35. The lower cover unit 37 is attached to the outer bottom surface side of the lower case unit 35 and covers the illumination unit 13 and the display 14.

The upper case unit 36 is attached to the top of the lower case unit 35 to close an opening unit of the lower case unit 35 that opens upward. The upper case unit 36 has a frame shape having an opening unit 36a through which the display light L traveling from the concave mirror 12 toward the windshield 19 passes. The opening unit 36a of the upper case unit 36 is closed by a light-transmitting plate unit 36b through which light including the display light L passes.

The blind cover 40 is provided in the case 30 and forms an optical path space S through which the display light L travels inside the case 30. The blind cover 40 hides structures and shapes that may generate stray light from the optical path space S (for example, a rib structure formed in the case 30 and the mirror rotation drive unit 18). The blind cover 40 is integrally formed from a metal. The metal may be a general metal or a light metal. Light metals such as aluminum alloys and magnesium alloys are more preferred. The blind cover 40 is formed to cover an area where parallel light such as sunlight that may enter through the opening unit 36a of the case 30 is concentrated by the concave mirror 12.

The blind cover 40 is formed by a method such as casting, die casting, punching, bending, or the like, but may be formed by another method.

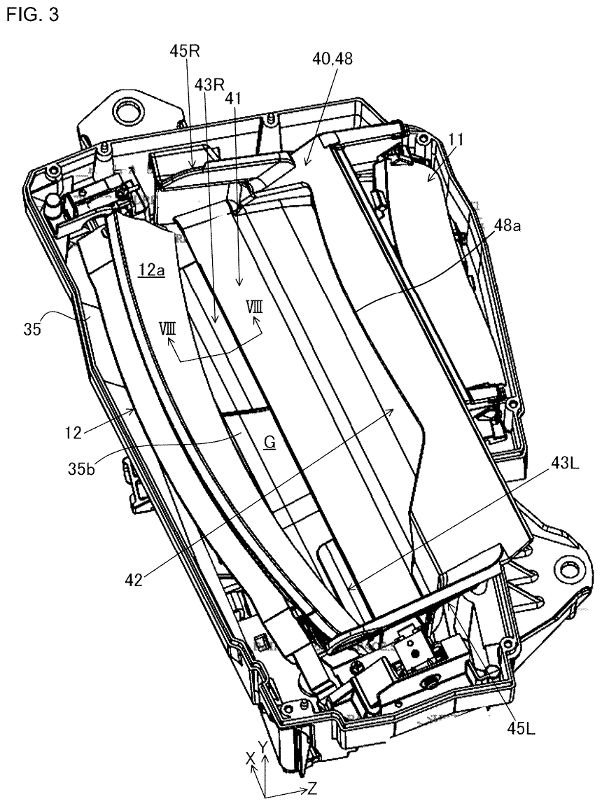

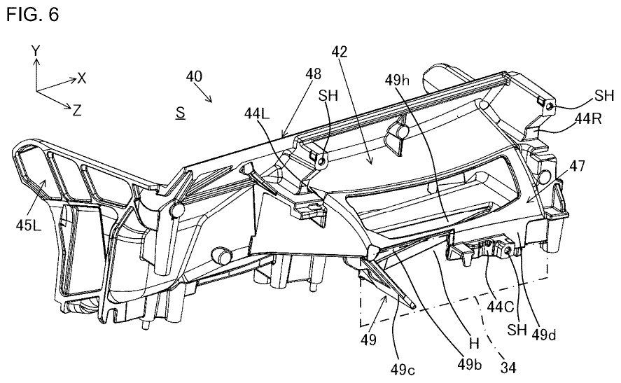

As illustrated in FIGS. 2 and 3, the blind cover 40 includes a bottom plate unit 41, extension units 43L and 43R, a pair of side wall units 45L and 45R, a light blocking wall 48, and an opening tube unit 42, and, as illustrated in FIG. 6, includes a mirror installation frame unit 47, receiving units 44L, 44R, and 44C, and a light entrance tube unit 49.

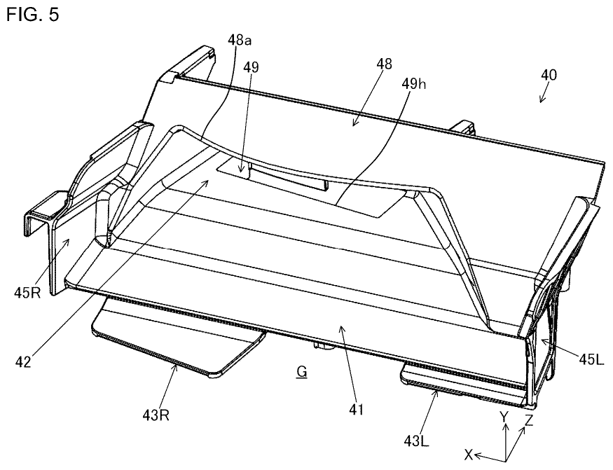

As illustrated in FIGS. 3 and 5, the bottom plate unit 41 has a plate shape, faces an inner bottom surface 35b of the lower case unit 35, and is formed between the concave mirror 12 and the correction mirror 11. The length of the bottom plate unit 41 in the X direction decreases from the concave mirror 12 toward the correction mirror 11.

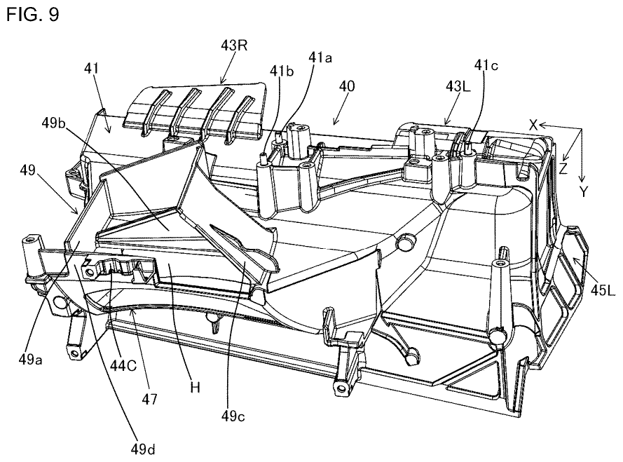

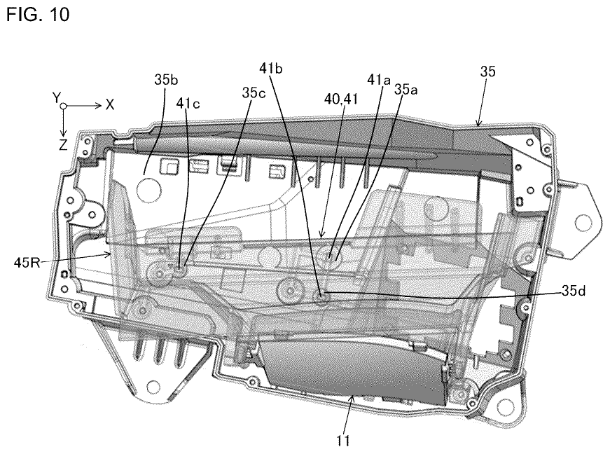

As illustrated in FIGS. 9 and 10, positioning pins 41a to 41c rise from the back surface (the surface opposite to the optical path space S) of the bottom plate unit 41. The positioning pins 41a to 41c are cylindrical and fit into hole units 35a, 35c, and 35d (see FIG. 10) formed in the inner bottom surface 35b of the lower case unit 35.

As a result, the blind cover 40 is positioned on the lower case unit 35. The positioning pin 41b is located approximately in the center of the back surface of the bottom plate unit 41.

The positioning pins 41a and 41b are arranged in the Z direction and are located to face the correction mirror 11 in the Z direction. The positioning pin 41c is located not to face the correction mirror 11 in the Z direction, and specifically, is located closer to the side wall unit 45R than the correction mirror 11. The distance between each of the positioning pins 41a and 41b and the correction mirror 11 is shorter than the distance between the positioning pin 41c and the correction mirror 11. The side wall units 45L and 45R do not have positioning pins.

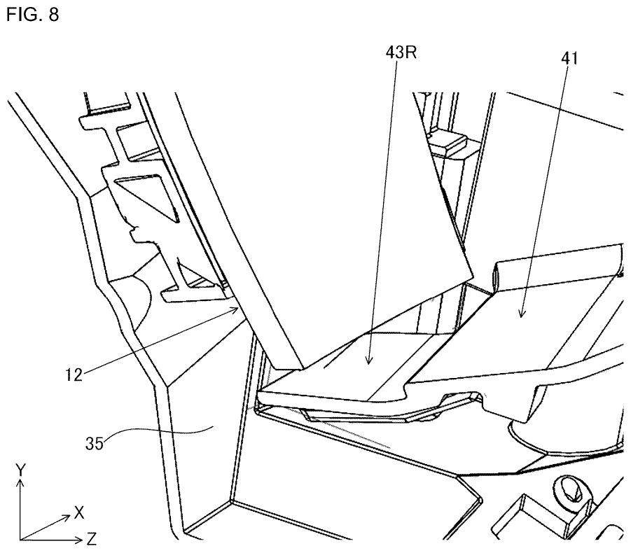

As illustrated in FIGS. 3, 5 and 8, the extension units 43L and 43R are located at the end unit of the bottom plate unit 41 on the correction mirror 11 side and on both sides in the X direction. The extension units 43L and 43R are connected to the underside of the end unit of the bottom plate unit 41 on the correction mirror 11 side. The extension units 43L and 43R extend to positions that are below the lower end surface of the concave mirror 12 and that are spaced apart in both outward directions from the center unit of the lower end surface in the X direction.

The length of the extension unit 43R in the Z direction decreases with distance from the extension unit 43L in the X direction. The extension unit 43L has a shape with a length in the Z direction that is constant in the X direction. The minimum length of the extension unit 43R in the Z direction is longer than the length of the extension unit 43L in the Z direction. A gap G is formed between the extension units 43L and 43R in the X direction. In the gap G, the center unit in the X direction of the lower end surface of the concave mirror 12 is located. Here, the center unit in the X direction of the lower end surface of the concave mirror 12 is located at a lowermost position, and the lower end surface curves upward from the center unit toward the outside in the X direction. The formation of gap G suppresses contact between the extension units 43L and 43R and the lower end surface of concave mirror 12.

As illustrated in FIG. 3, the pair of side wall units 45L and 45R extend to rise from both outer end units of the bottom plate unit 41 in the X direction. The pair of side wall units 45L and 45R are formed between the light blocking wall 48 and the reflecting surface 12a in the Z direction. The pair of side wall units 45L and 45R are formed such that the inter-surface distance between the pair of side wall units 45L and 45R increases with distance from the correction mirror 11 toward the concave mirror 12.

As illustrated in FIGS. 1 and 3, the light blocking wall 48 is inclined to hang down from the rear edge unit of the opening unit 36a of the case 30 in the Z direction. The light blocking wall 48 blocks sunlight traveling from the outside of the head-up display device 10 toward the correction mirror 11 and the display 14. The light blocking wall 48 has a plate shape extending in the X direction and inclined to approach the bottom plate unit 41 with distance from the correction mirror 11 toward the concave mirror 12. The end units of the side wall units 45L and 45R on the correction mirror 11 side are connected to both ends in the X direction of the upper surface of the light blocking wall 48. The light blocking wall 48 has a cutout unit 48a that opens toward the bottom plate unit 41. The peripheral end unit of the cutout unit 48a is connected to the end unit of the opening tube unit 42 on the concave mirror 12 side.

As illustrated in FIG. 6, the opening tube unit 42 is located on the back surface side of the light blocking wall 48 (the opposite side to the optical path space S) and has a tube shape surrounding the outer periphery of the display light L reflected by the correction mirror 11.

The mirror installation frame unit 47 is located at the end unit of the opening tube unit 42 on the opposite side to the light blocking wall 48. The mirror installation frame unit 47 has a frame shape that covers the outer periphery side of the reflecting surface of the correction mirror 11, and supports the correction mirror 11 by contacting with the outer periphery side of the reflecting surface of the correction mirror 11.

As illustrated in FIG. 4, the receiving units 44L, 44R, and 44C are located on the outer periphery side of the mirror installation frame unit 47, and are formed as recesses to support the pressed units 11L, 11R, and 11C of the correction mirror 11. Leaf springs 39L, 39R, and 39C press the pressed units 11L, 11R, and 11C in the receiving units 44L, 44R, and 44C, and thereby holds the pressed units 11L, 11R, and 11C in the receiving units 44L, 44R, and 44C. Screw holes SH (see FIG. 6) for screws Sc for fixing the leaf springs 39L, 39R, and 39C open toward the rear.

The direction in which the screw holes SH open and the direction in which the receiving units 44L, 44R, and 44C open are the same and are the opposite direction to the traveling direction of the display light L reflected by the correction mirror 11 (a direction toward the rear of the vehicle). Therefore, the direction in which the correction mirror 11 is attached to the mirror installation frame unit 47 and the direction in which the leaf springs 39L, 39R, and 39C are screwed can be the same. This makes it easier to assemble the head-up display device 10.

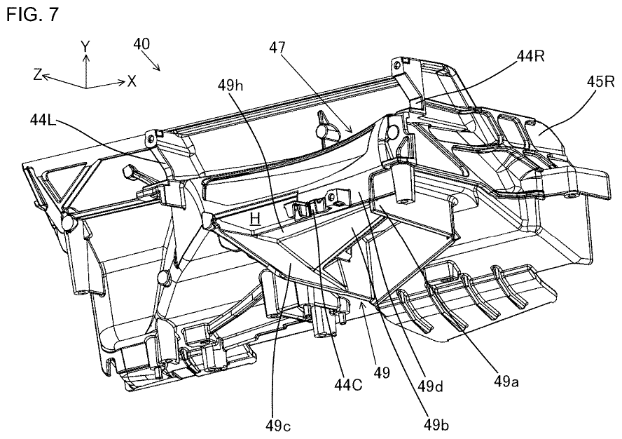

As illustrated in FIG. 7, the light entrance tube unit 49 surrounds the outer periphery of the display light L traveling from the display 14 to the correction mirror 11 and forms a tube shape that penetrates in the Y direction. The light entrance tube unit 49 is located to face the mirror installation frame unit 47 in the Y direction.

As illustrated in FIG. 5, the upper end unit of the light entrance tube unit 49 is connected to the bottom surface of the opening tube unit 42, to form an opening unit 49h through which the display light Lis emitted. The opening unit 49h is closer to the side wall unit 45R than the center of the blind cover 40 in the X direction. The light entrance tube unit 49 has a rectangular tube shape that is long in the X direction.

As illustrated in FIGS. 7 and 9, the light entrance tube unit 49 includes four wall units 49a to 49d that surround the outer periphery of the display light L from the display device 14.

The wall units 49a and 49c extend in the Z direction and are arranged in the X direction. The wall units 49b and 49d extend in the X direction and are arranged in the Z direction.

The wall unit 49a is located closer to the side wall unit 45R than the wall unit 49c. The wall unit 49a extends perpendicularly to the bottom plate unit 41. The wall unit 49c is inclined with respect to the bottom plate unit 41, and specifically, is inclined to approach the wall unit 49a as it goes downward.

The wall unit 49b is formed such that the height of the wall unit 49b from the bottom plate unit 41 decreases with distance from the wall unit 49c toward the wall unit 49a.

The wall unit 49d is located farther from the concave mirror 12 than the wall unit 49b, and has a plate shape with an area smaller than areas of the other wall units 49a to 49c. The receiving unit 44C is formed on the surface of the wall unit 49d opposite to the opening unit 49h.

The wall unit 49d has a plate shape that has a length in the X direction shorter than that of the wall unit 49b and a height in the Y direction lower than the maximum height of the wall unit 49b. One end of the wall unit 49d in the X direction (the left end in FIG. 9) is connected to the wall unit 49a, and the other end (the right end in FIG. 9) is spaced apart from the wall unit 49c with a gap H interposed therebetween. In the Z direction, the gap H faces a higher portion of the wall unit 49b.

As illustrated in FIGS. 4 and 6, the lower case unit 35 includes a closing unit 34 closing the gap H and the lower side of the wall unit 49d. The closing unit 34 is made of a resin and is a portion of the lower case unit 35. The closing unit 34 has a plate shape with a cutout to conform with the shape of the wall unit 49d. The light entrance tube unit 49 and the closing unit 34 closing the gap H and the lower side of the wall unit 49d form a closed tube shape. In this state, the closing unit 34 and the wall unit 49d form a single plate formed by the different materials.

The closing unit 34 may be formed integrally with the lower case unit 35 or may be formed separately.

### Effects

According to the embodiment described above, the following effects are achieved.
(1) The head-up display device 10 includes, the display 14 that emits the display light L, the correction mirror 11 that reflects the display light L to cause the upper end and the lower end of the display light L to cross each other, the concave mirror 12 that reflects the display light L to project the display light L outside the head-up display device 10, the case 30 made of a synthetic resin, housing the display 14, the correction mirror 11, and the concave mirror 12, and having the opening unit 36a through which the display light L passes, and the blind cover 40 made of metal, provided on the inner bottom surface 35b of the case 30, and forming the optical path space S through which the display light L travels within the case 30.

In the cross optical system in which the correction mirror 11 causes the upper and lower ends of the display light L to cross each other, the concave mirror 12 may concentrate sunlight (parallel light).

According to the above configuration, the blind cover 40 made of metal enhances heat resistance against heating caused by concentration of light in the cross optical system, and the case 30 made of a resin makes it possible to reduce the weight of the head-up display device 10.
(2) The blind cover 40 includes the light blocking wall 48 formed to hang down from a portion of the edge unit of the opening unit 36a. According to the configuration, the light blocking wall 48 at which sunlight may concentrate, is made of metal, and thus the heat resistance of the head-up display device 10 can be improved.
(3) The head-up display device 10 includes the mirror rotation drive unit 18 that rotates the concave mirror 12 around the rotation axis Ax extending in the left-right direction as seen by a viewer looking at a virtual image V, which is an example of a projected image displayed by the head-up display device 10. The blind cover 40 includes the bottom plate unit 41 located between the correction mirror 11 and the concave mirror 12 and located to face the inner bottom surface 35b of the case 30, and the extension units 43L and 43R formed on the end unit of the bottom plate unit 41 on the concave mirror 12 side and protruding toward positions below both the left and right end units of the concave mirror 12.

According to the configuration, the extension units 43L and 43R suppress exposure of visually unpleasant structures such as wirings inside the case 30 even when concave mirror 12 is rotated, and thereby improves the appearance of the inside of the case 30. Furthermore, the gap G formed between the two extension units 43L and 43R prevents the rotating concave mirror 12 from coming into contact with the blind cover 40. In addition, the formation of the gap G eliminates need for the concave mirror 12 to be spaced apart from the blind cover 40 to avoid such contact, and thus suppresses an increase in size of the head-up display device 10.
(4) The blind cover 40 includes a plurality of wall units 49a to 49d surrounding the outer periphery of the display light L traveling from the display 14 to the correction mirror 11. The plurality of wall units 49a to 49d include one wall unit 49d facing the inner side surface of the case 30 and at least a portion of the one wall unit 49d is omitted to form the gap H. The case 30 includes the closing unit 34 that closes the gap H.

According to the configuration, the closing unit 34 of the resin case 30 closing the gap H between the plurality of metal wall units 49a to 49d, makes it possible to reduce the weight compared to a case in which the entire tube is formed from metal. In addition, this configuration includes no double wall, and thus the head-up display device 10 can be made smaller.
(5) The blind cover 40 includes the mirror installation frame unit 47 holding the correction mirror 11 and having a frame shape. The correction mirror 11 can be attached to the mirror installation frame unit 47, from a direction along the traveling direction of the display light L reflected by the correction mirror 11.

According to the configuration, the head-up display device 10 can be manufactured more easily than a configuration in which the correction mirror 11 is attached to the mirror installation frame unit 47 from above.

Furthermore, the direction in which the correction mirror 11 is attached to the mirror installation frame unit 47 and the direction in which the screws Sc for fixing the correction mirror 11 to the mirror installation frame unit 47 are attached are the same. This makes it possible to easily attach and fix the correction mirror 11 to the mirror installation frame unit 47.
(6) The blind cover 40 includes, the bottom plate unit 41 located between the correction mirror 11 and the concave mirror 12 and facing the inner bottom surface 35b of the case 30, and the positioning pins 41a to 41c formed on the back surface of the bottom plate unit 41 facing the inner bottom surface 35b of the case 30. The positioning pins 41a to 41c are an example of a plurality of positioning units and positioned with respect to the hole units 35a, 35c, and 35d, which are formed on the inner bottom surface 35b of the case 30 and an example of counterpart positioning units. Among the plurality of positioning pins 41a to 41c, the positioning pins 41a and 41b are located to face the correction mirror 11 in the Z direction along the display light L traveling between the correction mirror 11 and the concave mirror 12.

The correction mirror 11 should be positioned with high accuracy. According to the above configuration, the positioning pins 41a and 41b enables positioning of the blind cover 40 at a location close to the correction mirror 11.

In addition, the positioning pins 41a to 41c formed on the bottom plate unit 41 enables more stable positioning than when the positioning pins 41a to 41c are formed on the side wall units 45L and 45R, because the bottom plate unit 41 is more rigid than the side wall units 45L and 45R.

Note that the present disclosure is not limited to the above-described embodiments and drawings. Appropriate modifications (including deletion of components) may be made without departing from the spirit of the present disclosure. Example variations will be described below.

### Variations

In the above embodiment, the mirror installation frame unit 47 and the receiving units 44L, 44R, and 44C may be formed separately from the blind cover 40 by using a resin or metal.

The light blocking wall 48 may be formed separately from the blind cover 40 by using a resin or metal. The light blocking wall 48 may be formed in the upper case unit 36.

The extension units 43L and 43R may be connected with each other in the X direction. In addition, either one or both of the extension units 43L and 43R may not be provided.

In the above embodiment, the mirror rotation drive unit 18 may not be provided. In this case, the concave mirror 12 may be non-rotatably fixed inside the case 30.

In the above embodiment, the light entrance tube unit 49 may be formed without the gap H. In this case, the closing unit 34 may not be provided.

In the above embodiment, the positions and number of the positioning pins 41a to 41c can be changed as appropriate. The positioning pins 41a to 41c may be formed on the side wall units 45L and 45R.

In the above embodiment, the correction mirror 11 may be a plane mirror.

In the above embodiment, the positioning pins 41a to 41c may be formed in the lower case unit 35, and the hole units 35a, 35c, and 35d may be formed in the blind cover 40.

In the above embodiment, the member on which an image is projected is the windshield 19. However, the member on which an image is projected may be a dedicated combiner. The head-up display device 10 is not limited to those mounted on a car, but may be a device mounted on other vehicles such as an airplane and a ship.

In the above embodiment, the display 14 is, for example, a TFT liquid crystal display panel, but is not limited thereto. Thus, the display 14 may include an organic EL display, a micro electro mechanical system (MEMS), or a digital micro-mirror device (DMD).

In the above embodiment, the blind cover 40 is not limited to being made of metal, and may be made of a resin. The correction mirror 11 may be a folding mirror that does not cross the display light L.

These variations are included in technical ideas described in the following supplementary notes.

### Supplementary Note 1

A head-up display device, including,
a display that emits display light,
a folding mirror that reflects the display light,
a concave mirror that reflects the display light to project the display light outside the head-up display device,
a case housing the display, the folding mirror, and the concave mirror, and having an opening unit through which the display light passes,
a blind cover provided on an inner bottom surface of the case, the blind cover forming an optical path space through which the display light travels within the case, and
a mirror rotation drive unit that rotates the concave mirror around a rotation axis extending in a left-right direction, wherein the blind cover includes,
a bottom plate unit located between the folding mirror and the concave mirror and facing the inner bottom surface of the case, and
an extension unit formed at an end unit of the bottom plate unit on the concave mirror side and protruding toward a position below the concave mirror.

### Supplementary Note 2

A head-up display device, including,
a display that emits display light,
a folding mirror that reflects the display light,
a concave mirror that reflects the display light to project the display light outside the head-up display device,
a case housing the display, the folding mirror, and the concave mirror, and having an opening unit through which the display light passes, and
a blind cover provided on an inner bottom surface of the case, the blind cover forming an optical path space through which the display light travels within the case, wherein
the blind cover includes a plurality of wall units surrounding an outer periphery of the display light traveling from the display to the folding mirror,
the plurality of wall units include one wall facing an inner side surface of the case and at least a portion of the one wall is omitted to form a gap, and
the case includes a closing unit that closes the gap.

### Supplementary Note 3

A head-up display device, including,
a display that emits display light,
a folding mirror that reflects the display light,
a concave mirror that reflects the display light to project the display light outside the head-up display device,
a case housing the display, the folding mirror, and the concave mirror, and having an opening unit through which the display light passes, and
a blind cover provided on an inner bottom surface of the case, the blind cover forming an optical path space through which the display light travels within the case, wherein
the blind cover includes a mirror installation frame unit holding the folding mirror and having a frame shape, and
the folding mirror is attached to the mirror installation frame unit, from a direction along a traveling direction of the display light reflected by the folding mirror.

### REFERENCE SIGNS LIST

10 . . . Head-up display device
11 . . . Correction mirror, 11C, 11L, 11R . . . Pressed unit, 11a . . . Reflecting surface
12 . . . Concave mirror, 12a. Reflecting surface
13 . . . Illumination unit
14 . . . Display
15 . . . Control board
18 . . . Mirror rotation drive unit
19 . . . Windshield
30 . . . Case, 34 . . . Closing unit, 35 . . . Lower case unit, 35b. . . Inner bottom surface, 35a, 35c, 35d. . . Hole unit, 36 . . . Upper case unit, 36a. . . Opening unit, 36b. . . Light-transmitting plate unit, 37 . . . Lower cover unit, 39L, 39R, 39C . . . Leaf spring
40 . . . Blind cover, 41 . . . Bottom plate unit, 41a to 41c. . . Positioning pin, 42 . . . Opening tube unit, 43L, 43R . . . Extension unit, 44C, 44L, 44R . . . Receiving unit, 45L, 45R . . . Side wall unit, 47 . . . Mirror installation frame unit, 48. Light blocking wall, 48a. . . Cutout unit, 49 . . . Light entrance tube unit, 49a to 49d. Wall unit, 49h . . . Opening unit
CP . . . Cross point, G . . . Gap, H . . . Gap, L . . . Display light, S . . . Optical path space, SH . . . Screw hole, Sc . . . Screw, Ax . . . Rotation axis

1. A head-up display device, comprising:
a display that emits display light;
a correction mirror that reflects the display light to cause an upper end and a lower end of the display light to cross each other;
a concave mirror that reflects the display light to project the display light outside the head-up display device;
a case made of a synthetic resin, the case housing the display, the correction mirror, and the concave mirror, the case having an opening unit through which the display light passes; and
a blind cover made of metal and provided on an inner bottom surface of the case, the blind cover forming an optical path space through which the display light travels within the case.

2. The head-up display device according to claim 1, wherein the blind cover includes a light blocking wall extending from a portion of an edge unit of the opening unit, to block sunlight.

3. The head-up display device according to claim 1, comprising a mirror rotation drive unit that rotates the concave mirror around a rotation axis extending in a left-right direction, wherein
the blind cover includes,
a bottom plate unit located between the correction mirror and the concave mirror and facing the inner bottom surface of the case, and
an extension unit formed at an end unit of the bottom plate unit on the concave mirror side and protruding toward a position below the concave mirror.

4. The head-up display device according to claim 1, wherein
the blind cover includes a plurality of wall units surrounding an outer periphery of the display light traveling from the display to the correction mirror,
the plurality of wall units include one wall facing an inner side surface of the case and at least a portion of the one wall is omitted to form a gap, and
the case includes a closing unit that closes the gap.

5. The head-up display device according to claim 1, wherein
the blind cover includes a mirror installation frame unit holding the correction mirror and having a frame shape, and
the correction mirror is attached to the mirror installation frame unit, from a direction along a traveling direction of the display light reflected by the correction mirror.

6. The head-up display device according to claim 1, wherein
the blind cover includes,
a bottom plate unit located between the correction mirror and the concave mirror and facing the inner bottom surface of the case, and
a plurality of positioning units formed on a back surface of the bottom plate unit facing the inner bottom surface of the case, each of the plurality of positioning units being positioned with respect to a counterpart positioning unit formed on the inner bottom surface of the case, and
at least one of the plurality of positioning units is located to face the correction mirror in a direction along the display light traveling between the correction mirror and the concave mirror.
